(19) United States
(12) Patent Application Publication
(10) Pub. No.: US 2026/0291084 A1
(43) Pub. Date: Sep. 24, 2026

(54) PORTABLE AND RECONFIGURABLE SATELLITE COMMUNICATION SYSTEMS

(71) Applicant: CesiumAstro, Inc., Austin, TX (US)

(72) Inventors: Shey Sabripour, Austin, TX (US); Spencer Erekson, Superior, CO (US); Enrique Sifuentes, Austin, TX (US); Thomas Henry Hand, Highlands Ranch, CO (US); Ben Murphy, Austin, TX (US)

(21) Appl. No.: 19/546,159

(22) Filed: Feb. 20, 2026

Related U.S. Application Data
(60) Provisional application No. 63/762,052, filed on Feb. 23, 2025.

(51) Int. Cl. H01Q 21/00; H01Q 1/24; H01Q 3/22

(52) U.S. Cl. CPC H01Q 21/0025; H01Q 1/243; H01Q 3/22

(57) ABSTRACT

The present disclosure provides for a variety of portable and lightweight satellite communication systems and devices, which allows for both satellite-based data transmission and data reception. Such devices can provide additional communication functionality as well, such as providing wireless communication capability and being able to serve as a hotspot to provide network (e.g., Internet) access to various other devices, such as cell phones and tablet computers. In at least one embodiment, such a device can have built-in phased array antennas to receive and transmit over radio frequencies. Such a device may also include one or more solar cells that allow for recharging of one or more internal batteries. Such a device can have a slim form factor and lightness that make it easily transportable.

### CROSS-REFERENCE TO RELATED APPLICATIONS

This application claims the benefit of U.S. Provisional Patent Application No. 63/762,052, filed Feb. 23, 2025, which is incorporated by reference herein in its entirety.

### TECHNICAL FIELD

This disclosure relates generally to satellite communication devices and systems, and in at least one embodiment relates to lightweight and portable satellite communication devices that allow for additional functionality such as wireless communications and solar charging.

### BACKGROUND

There is an ever-increasing need for data communication channels in various locations and with multiple capabilities. In many instances, devices that offer multiple communication options—particularly those with transmission and reception options for satellite communications—tend to have a large size envelope, mass and power, as well as capability limitations. Such devices also can consume a significant amount of power, which can cause difficulties when in locations where DC power access or charging may not be readily available.

### BRIEF DESCRIPTION OF THE DRAWINGS

Various embodiments in accordance with the present disclosure will be described with reference to the drawings, in which:

FIG. 1 illustrates an example system 100 that can be used for satellite-based data communication, according to at least one embodiment.

FIG. 2 illustrates an example portable satellite communication device, according to at least one embodiment.

FIG. 3 illustrates advantages of portability of a satellite communication device, according to at least one embodiment.

FIG. 4 illustrates a perspective view of a satellite communication device with solar cells that are able to be tilted independently, according to at least one embodiment.

FIG. 5 illustrates an example foldable four-part satellite communication device, according to at least one embodiment.

FIG. 6 illustrates components of an example computing device, according to at least one embodiment.

FIG. 7 illustrates an example PAA system, according to at least one embodiment.

FIG. 8 illustrates an example PAA system architecture, according to at least one embodiment.

### BRIEF SUMMARY

Approaches in accordance with various embodiments provide for a variety of portable and lightweight satellite communication systems and devices, which allow for both satellite-based data transmission and data reception. Such devices can provide for additional communications as well, such as providing local wireless communication capability and being able to serve as a hotspot to provide network (e.g., Internet) access to various other devices, such as cell phones and tablet computers. In at least one embodiment, such a device can have built-in phased array antennas to receive and transmit over radio frequencies. Such a device may also include one or more solar cells that allow for recharging of one or more internal batteries. Such a device can have a slim form factor and lightness that make it easily transportable. While being lightweight and portable, communications devices in at least some embodiments can also be rugged enough to be used in military or rough terrain applications that may be far from power or network access.

### TECHNICAL DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

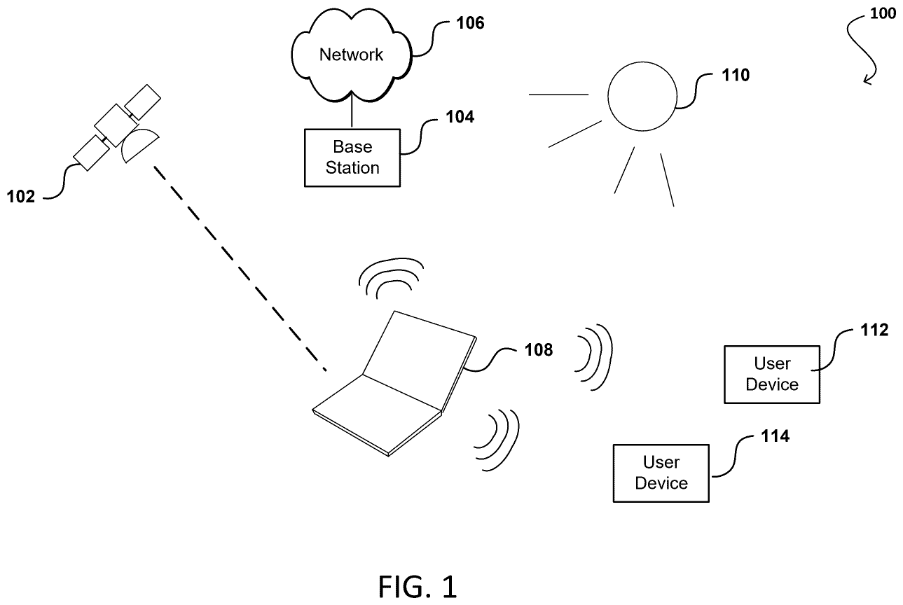

FIG. 1 illustrates an example environment 100 in which a communication device can operate within the scope of at least one embodiment. In this example, a portable communication device 108 is able to communicate with one or more satellites 102 for purposes of data transmission and reception. This may include, for example, multiple constellation, multi-orbit, multi-frequency, and/or multi-beam connectivity. The data transmission can be for any appropriate purpose, such as to provide a secondary data channel option when other channels, such as Wi-Fi or wired Internet connections, are not available. The portable communication device 108 can also include wireless communication capability, such as circuitry and components supporting wireless network communications to a base station 104 or nearby tower, for example, which can be connected to an appropriate communications network 106 such as the Internet, an Ethernet, a cellular network, and the like. In some instances, the portable communication device 108 may not connect to such a base station 104 but may use the satellite network to receive and transmit data, and can use a local wireless communication to transmit and receive that data with respect to other nearby devices. For example, such wireless communications may also be possible with respect to other devices, including user devices 112, 114 for other terrestrial users with terrestrial network connectivity, where such user devices may include other portable communication devices, smartphones, or tablet computers, which may communicate over the same network channel or a peer network, among other such options. As illustrated, an example portable communication device 108 can also include one or more solar cells, or other photovoltaic devices, that allow for capturing solar energy from a sun 110 (or other such source) and recharging of one or more internal batteries. Although not illustrated in FIG. 1, such a device may include one or more ports or power cords that allow for plugged-in or conventional recharging or power from a wired power delivery network or source, such as a power outlet, generator, or external solar array.

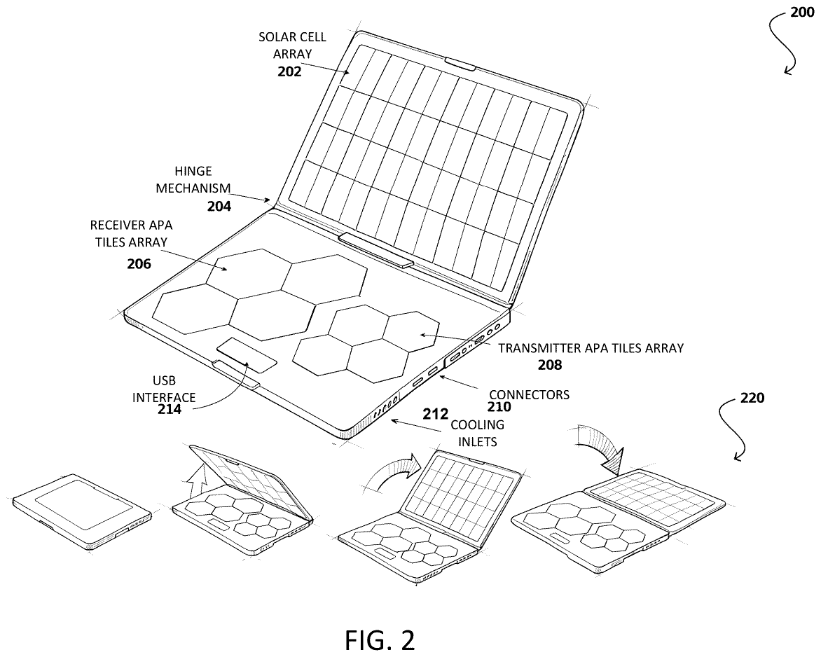

FIG. 2 illustrates various perspective views 200 of an example portable communication device in accordance with at least one embodiment. As illustrated, such a device can have two primary housing portions connected by a hinge mechanism 204. Such a design allows for compact transport by being able to fold the device using the hinge mechanism 204, while allowing for additional surface area when folded into an open and flat orientation where the two housing portions are arranged substantially coplanar. In this example device, a first housing portion includes two separate phased arrays, including an array 206 of APA (Active Phased Array) receiver tiles and an array 208 of APA transmitter tiles. The APA may also be a single phased array that performs both the transmit and receive functions. In at least one embodiment, the transmit and receive arrays are not separate, as TxRx could exist as a single aperture for TDD (Time Division Duplexing) applications. An APA or active electronically scanned array (AESA) is a phased array in which each antenna element has a phase shifter at each element to electronically steer the antenna beam. Phased Array Antenna (PAA) technology used in an example portable communications device can include APA or passive phased array technology, as may include frequency-selective surfaces antenna technology.

Each array can function as an independent PAA, allowing for reception of a signal from a satellite using the first array 206, and transmission of a signal to a satellite using a second array 208. The size, number, configuration, and materials of these arrays may include any selection known, used, or subsequently developed for such purposes. The first housing portion also is illustrated in FIG. 2 to include a user interface 214, such as may be provided using one or more elements such as a touch screen, LCD display, keyboard, mouse, touchpoint, and the like. Such a device may also provide haptic, audio, or other types of feedback using corresponding mechanisms. The first housing portion is also illustrated to include one or more connectors 210, such as USB ports, HDMI ports, and the like, which can allow for hardwired connection to other peripherals for various purposes. The device as illustrated also includes a number of cooling inlets 212 to allow for heated air to escape, or be directed from, the device. The device may include one or more heat sinks, heat pipes, vapor chambers, fans, or other such elements to further assist with cooling and/or temperature regulation. Although illustrated in the first housing portion, it should be understood that elements such as the connectors and user interface could be located in the second housing portion as well in other embodiments.

In this example device, the second housing portion includes a solar cell array 202 that can capture solar energy for use in powering the device, as well as for charging at least one rechargeable battery, as may be located in the first housing portion. As illustrated, the second housing portion may be placed flat or at various angles in order to capture the most amount of sunlight. For example, a user may open the device about the hinge to position the solar cells so that normal vectors from the planar surfaces of the cells point substantially in the direction of the sun, or may at least open the device so the solar cells lay flat and can capture at least some solar energy when the sun is at any (functional) angle of the solar cells, such as the such being within +/−60 degrees of normal (or another such value). A solar tracking array can also be used in some embodiments, where a solar array setup can be external to the phased array, and externally track the sun over time to ensure maximum power capture. Devices thus can use passive and/or active solar trackers, and may beneficially use (or at least offer) both. A number of views 220 is illustrated with the example device opened in various angular configurations. In at least one embodiment, a phased array and/or solar array can be expandable for larger apertures, larger throughputs, larger gain, larger power, and/or faster charging, among other such options. The solar cells do not have to be part of a PAA assembly—they can be external to the PAA. Other components, such as an external battery, generator, or wall source, could also be used.

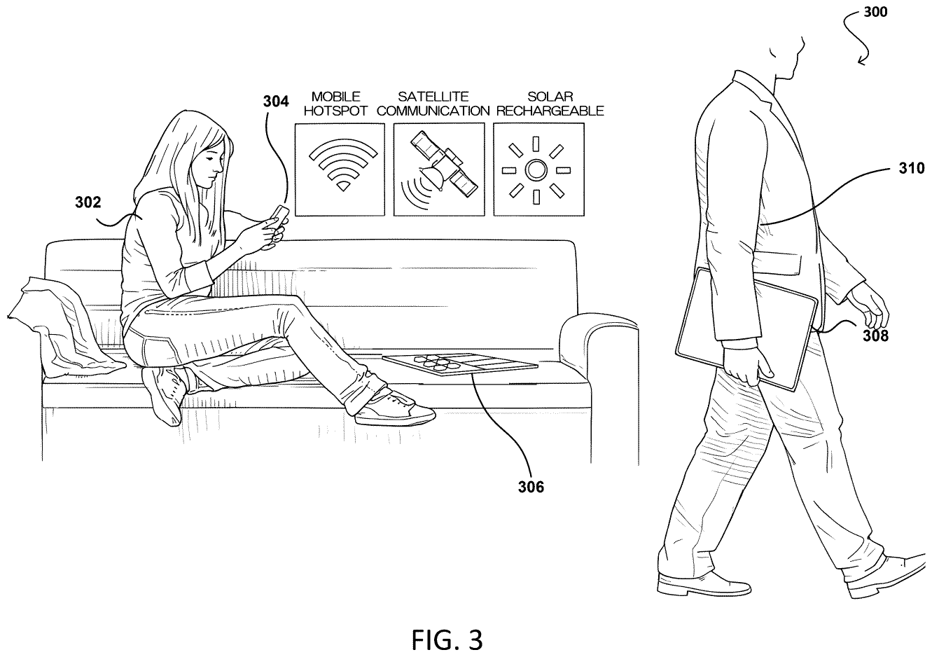

FIG. 3 illustrates views 300 of potential uses of example portable communication devices 306, 308 according to at least one embodiment. In a first example, a user 302 is using a user device, here a smartphone, which involves the transmission and reception of data over a wireless signal. In this example, the portable communication device 306 is able to receive network data, such as over a satellite connection, and is able to transmit that data to the user device 304 over a local wireless communication, such as a local area network (LAN), Wi-Fi, Bluetooth, or similar such communication channel. In this example, the portable communication device 306 is able to function as a hotspot for connected nearby devices, such as the user device 304, to allow for data communications even in places or situations where other networks (e.g., cellular networks or physically connected networks) are not available, or are at least not preferred or desirable for certain use. As illustrated, the portable communication device is folded out flat to allow for solar recharging and satellite communications. The orientation of the device may not matter for functionality such as hotspot functionality. Also as illustrated, when not in use a portable communication device 308 can be folded into a closed orientation, which allows for easy transport in, for example, the arm 310 of a user. Such a device can be lightweight, slim, and portable in design and function.

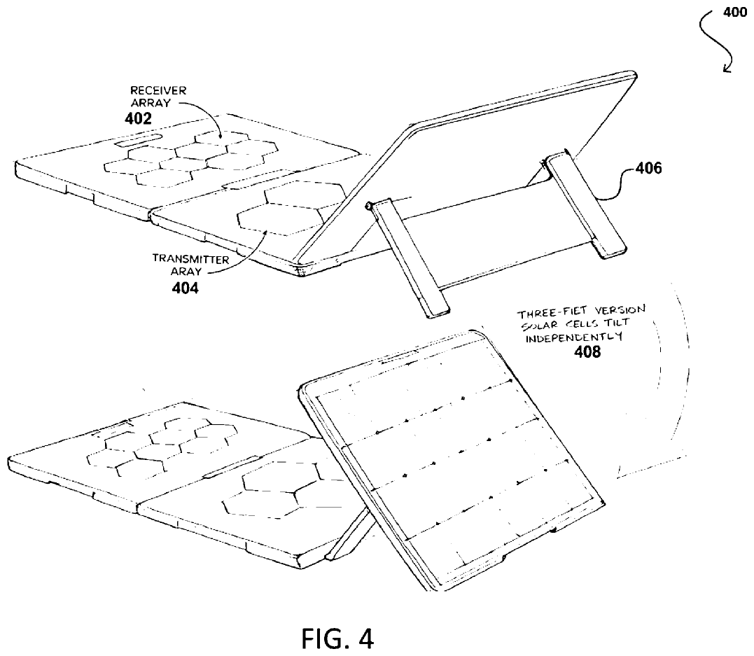

FIG. 4 illustrates perspective views of another example portable communication device 400 in accordance with at least one embodiment. In this example device 400, there are at least three separate housing portions 408. A first housing portion can include a receive PAA 402, and potentially a user interface or other such element. A second housing portion can be connected to the first housing portion by at least one hinge or other such mechanism, and can include a transmit PAA 404. Such a design can allow for arrays of greater size and/or number of antenna elements than when the arrays are on a single housing portion, and/or can allow for housing portions of smaller dimensions by separating the arrays into separate portions. The separate array portions may function as independent arrays for receive, transmit, or multi-beam functions or together as one large single array. As illustrated, there is a third housing portion that includes a number of solar cells. In this example, the solar cells can be rotated along at least one hinge or other such mechanism that connects to at least one of the first and second housing portions, but enables the solar cells to be positioned in any appropriate orientation to maximize the capture of solar energy based in part on the direction to the sun or other source of energy. As illustrated, an integrated stand 406 or similar element can be used to support the third housing portion and/or solar cells in the appropriate orientation.

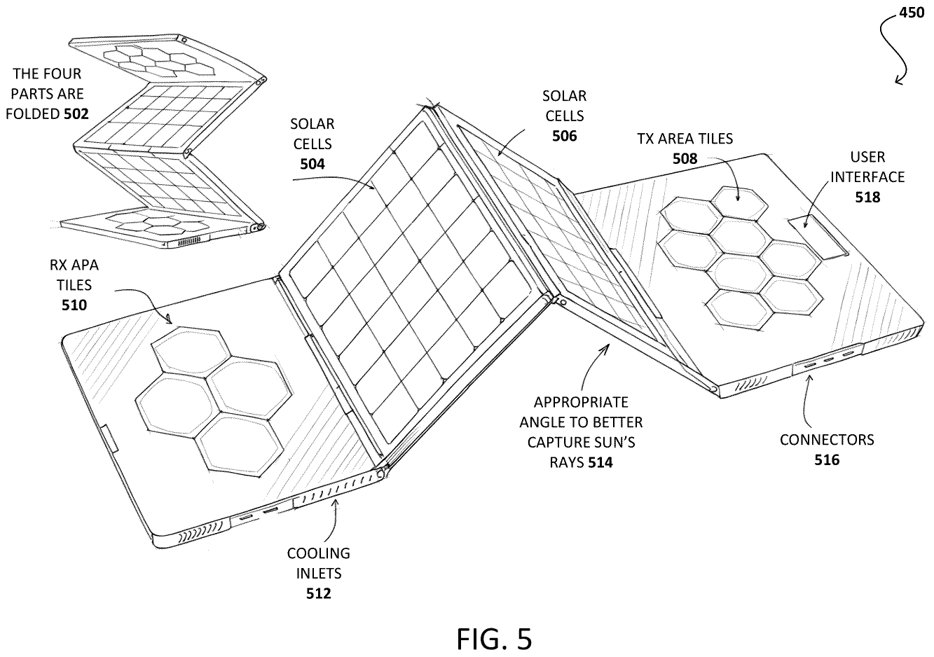

FIG. 5 illustrates views of a four-part portable communication device 500 that includes four connected housing portions. In this example, there are two housing portions that each include a phased array, one including the receive array 510 and another including the transmission array 508. There are two portions connected in a middle section or region of the portable communication device that include solar cells 504, 506. Being in the middle portion allows these cells to be positioned in similar (but opposing) angles in this orientation, which can help to provide an appropriate angle 514 for at least one of the solar cell arrays 506 to capture the sun's rays. Cooling inlets 512, connectors 516, a user interface 518, and/or other such elements can be placed in any of the housing portions as appropriate. As illustrated, the device can be folded 502 using hinges (accordion-style or otherwise) to reduce the effective size of the device for transport or storage.

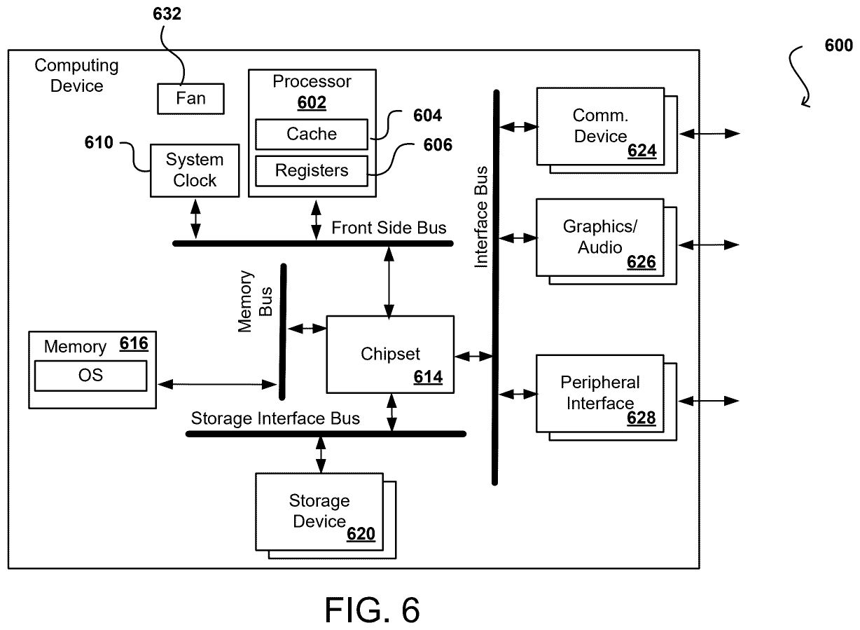

FIG. 6 illustrates example computing components that might be contained within such a portable computing device, and that might work with a satellite communication subsystem and/or wireless hotspot subsystem. It should be understood that there can be various such components provided in various arrangements in different devices. The computing resource 600 (e.g., a portable communications device) will have one or more processors 602, such as central processing units (CPUs), graphics processing units (GPUs), and the like, that are electronically and/or communicatively coupled with various components using various buses, traces, and other such mechanisms. A system clock 610 may be used to provide a synchronizing reference signal to various components of the computing resource 600. A processor 602 can include memory registers 606 and cache memory 604 for holding instructions, data, and the like. In this example, a chipset 614, which can include a northbridge and southbridge in some embodiments, can work with the various system buses to connect the processor 602 to components such as memory 616, in the form or physical RAM or ROM, which can include the code for the operating system as well as various other instructions and data utilized for operation of the computing device. The computing device can also contain, or communicate with, one or more storage devices 620, such as hard drives, flash drives, optical storage, and the like, for persisting data and instructions similar, or in addition to, those stored in the processor and memory. The processor 602 can also communicate with various other components via the chipset 614 and an interface bus (or graphics bus, etc.), where those components can include communications devices 624 such as cellular modems or network cards, media components 626, such as graphics cards and audio components, and peripheral interfaces 628 for connecting peripheral devices, such as printers, keyboards, and the like. At least one cooling fan 632 or other such temperature regulating or reduction component can also be included as well, which can be driven by the processor or triggered by various other sensors or components on, or remote from, the device. Various other or alternative components and configurations can be utilized as well as known in the art for computing devices.

At least one processor 602 can obtain data from physical memory 616, such as a dynamic random access memory (DRAM) module, via a coherency fabric in some embodiments. It should be understood that various architectures can be utilized for such a computing device, which can include varying selections, numbers, and arguments of buses and bridges within the scope of the various embodiments. The data in memory can be managed and accessed by a memory controller, such as a DDR controller, through the coherency fabric. The data can be temporarily stored in a processor cache 604 in at least some embodiments. The computing resource 600 can also support multiple I/O devices using a set of I/O controllers connected via an I/O bus. There can be I/O controllers to support respective types of I/O devices, such as a universal serial bus (USB) device, data storage (e.g., flash or disk storage), a network card, a peripheral component interconnect express (PCIe) card or interface 628, a communication device 624, a graphics or audio card 626, and a direct memory access (DMA) card, among other such options. In some embodiments, components such as the processor, controllers, and caches can be configured on a single card, board, or chip (i.e., a system-on-chip implementation), while in other embodiments, at least some of the components can be located in different locations, etc.

An operating system (OS) running on the processor 602 can help to manage the various devices that can be utilized to provide input to be processed. This can include, for example, utilizing relevant device drivers to enable interaction with various I/O devices, where those devices can relate to data storage, device communications, user interfaces, and the like. The various I/O devices will typically connect via various device ports and communicate with the processor and other device components over one or more buses. There can be specific types of buses that provide for communications according to specific protocols, as may include peripheral component interconnect (PCI) or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Such a device can be used, for example, as part of a computing system or network. Such computers often have a need to perform tasks outside the environment of the CPU and main memory (i.e., RAM). For example, the device can need to communicate with external entities (e.g., other servers) or process data using an external processor (e.g., a General Purpose Graphical Processing Unit (GPGPU)). In such cases, the CPU can interface with one or more I/O devices. In some cases, these I/O devices can be special-purpose hardware designed to perform a specific role. For example, an Ethernet network interface controller (NIC) can be implemented as an application-specific integrated circuit (ASIC) comprising digital logic operable to send and receive packets.

In an illustrative embodiment, a host computing device is associated with various hardware components, software components and respective configurations that facilitate the execution of I/O requests. One such component is an I/O adapter that inputs and/or outputs data along a communication channel. In one aspect, the I/O adapter device can communicate as a standard bridge component for facilitating access between various physical and emulated components and a communication channel. In another aspect, the I/O adapter device can include embedded microprocessors to allow the I/O adapter device to execute computer executable instructions related to the implementation of management functions or the management of one or more such management functions, or to execute other computer executable instructions related to the implementation of the I/O adapter device. In some embodiments, the I/O adapter device can be implemented using multiple discrete hardware elements, such as multiple cards or other devices. A management controller can be configured in such a way to be electrically isolated from any other component in the host device other than the I/O adapter device. In some embodiments, the I/O adapter device is attached externally to the host device. In some embodiments, the I/O adapter device is internally integrated into the host device. Also in communication with the I/O adapter device can be an external communication port component for establishing communication channels between the host device and one or more network-based services or other network-attached or direct-attached computing devices. The I/O adapter device can utilize the external communication port component to maintain communication channels between one or more services and the host device, such as health check services, financial services, and the like.

The I/O adapter device can also be in communication with a Basic Input/Output System (BIOS) component. The BIOS component can include non-transitory executable code, often referred to as firmware, which can be executed by one or more processors and used to cause components of the host device to initialize and identify system devices such as the video display card, keyboard and mouse, hard disk drive, optical disk drive and other hardware. The BIOS component can also include or locate boot loader software that will be utilized to boot the host device. For example, in one embodiment, the BIOS component can include executable code that, when executed by a processor, causes the host device to attempt to locate Preboot Execution Environment (PXE) boot software. Additionally, the BIOS component can include or take the benefit of a hardware latch that is electrically controlled by the I/O adapter device. The hardware latch can restrict access to one or more aspects of the BIOS component, such as controlling modifications or configurations of the executable code maintained in the BIOS component. The BIOS component can be connected to (or in communication with) a number of additional computing device components, such as processors, memory, and the like. In one embodiment, such computing device resource components can be physical computing device resources in communication with other components via the communication channel. The communication channel can correspond to one or more communication buses, such as a shared bus (e.g., a front side bus, a memory bus), a point-to-point bus such as a PCI or PCI Express bus, etc., in which the components of the bare metal host device communicate. Other types of communication channels, communication media, communication buses or communication protocols (e.g., the Ethernet communication protocol) can also be utilized. Additionally, in other embodiments, one or more of the computing device resource components can be virtualized hardware components emulated by the host device. In such embodiments, the I/O adapter device can implement a management process in which a host device is configured with physical or emulated hardware components based on a variety of criteria. The computing device resource components can be in communication with the I/O adapter device via the communication channel. In addition, a communication channel can connect a PCI Express device to a CPU via a northbridge or host bridge, among other such options.

In communication with the I/O adapter device via the communication channel can be one or more controller components for managing hard drives or other forms of memory. An example of a controller component can be a SATA hard drive controller. Similar to the BIOS component, the controller components can include or take the benefit of a hardware latch that is electrically controlled by the I/O adapter device. The hardware latch can restrict access to one or more aspects of the controller component. Illustratively, the hardware latches can be controlled together or independently. For example, the I/O adapter device can selectively close a hardware latch for one or more components based on a trust level associated with a particular user. In another example, the I/O adapter device can selectively close a hardware latch for one or more components based on a trust level associated with an author or distributor of the executable code to be executed by the I/O adapter device. In a further example, the I/O adapter device can selectively close a hardware latch for one or more components based on a trust level associated with the component itself. The host device can also include additional components that are in communication with one or more of the illustrative components associated with the host device. Such components can include devices, such as one or more controllers in combination with one or more peripheral devices, such as hard disks or other storage devices. Additionally, the additional components of the host device can include another set of peripheral devices, such as Graphics Processing Units (“GPUs”). The peripheral devices can also be associated with hardware latches for restricting access to one or more aspects of the component. As mentioned above, in one embodiment, the hardware latches can be controlled together or independently.

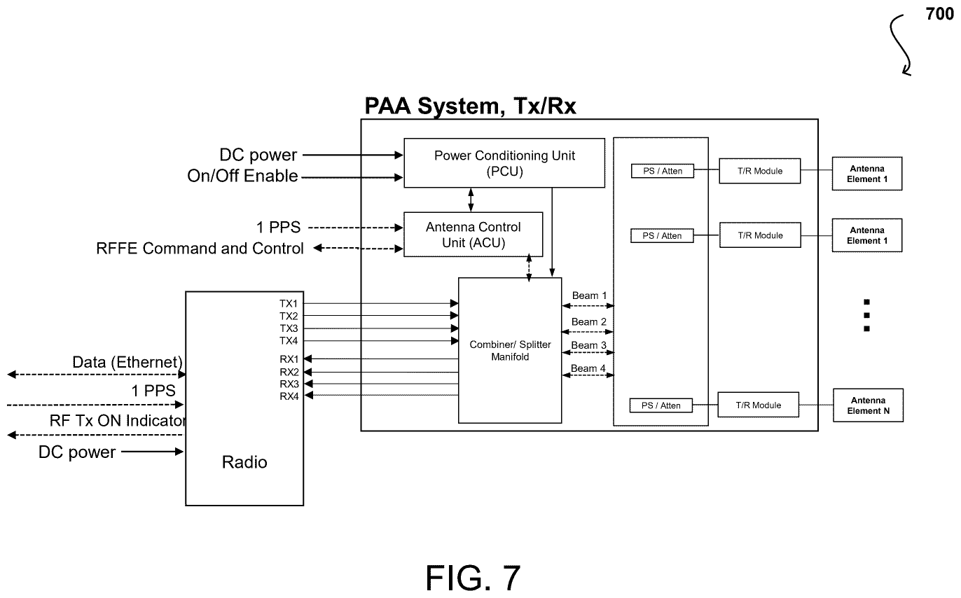

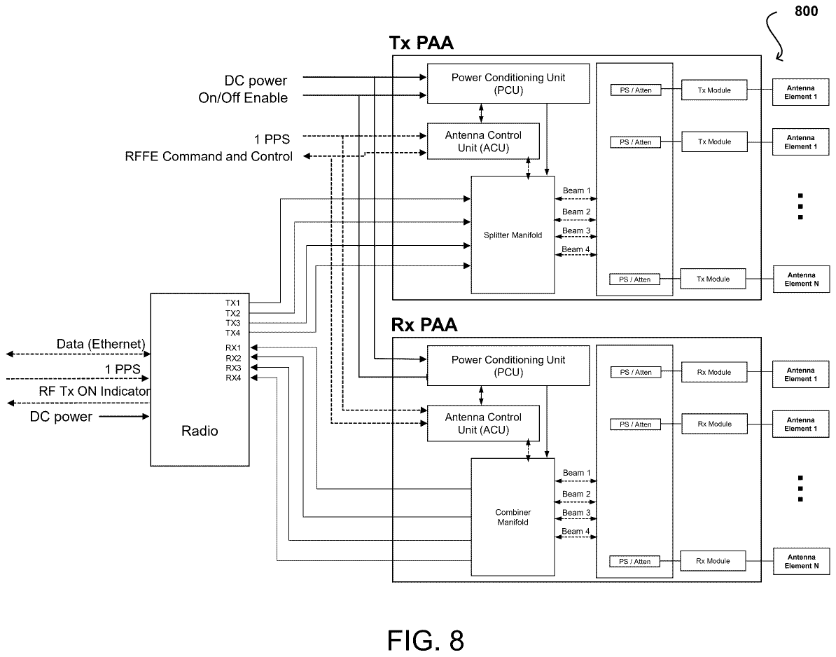

FIG. 7 illustrates an example PAA System 700, with both transmit and receive capability, according to at least one embodiment. FIG. 8 illustrates a PAA system block diagram 800, with separate transmit and receive apertures. Such mechanisms can be used in various portable communication devices as disclosed and suggested elsewhere herein.

Other variations are possible as well within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) can be performed under at least partial control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms such as “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In the present disclosure, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A portable communications device, comprising:
a first housing portion including at least one tile array and circuitry to allow for transmission and reception of data with respect to one or more satellites; and
a second housing portion rotatably attached to the first housing portion using at least one hinge mechanism, the second housing portion including at least one solar cell useful for powering the circuitry of the first housing portion.

2. The portable communications device of claim 1, wherein the at least one tile array includes a first active phased-array (APA) antenna assembly for transmission of data and a second APA antenna assembly for reception of data.

3. The portable communications device of claim 2, wherein the first housing portion includes a first sub-portion including the first APA antenna assembly and a second sub-portion including the second APA antenna assembly, wherein the first and second sub-portions are attached to the second housing portion using one or more additional hinge mechanisms.

4. The portable communications device of claim 1, wherein the second housing portion includes a first sub-portion including a first subset of solar cells and a second sub-portion including a second subset of solar cells, wherein the first and second sub-portions are attached to the second housing portion using one or more additional hinge mechanisms allowing for the first sub-portion and the second sub-portion to be positioned at different angles with respect to incoming sunlight.

5. The portable communications device of claim 1, wherein the portable communications device is able to function as a hotspot to one or more wirelessly connected devices, allowing the one or more wirelessly connected devices to share in transmission and reception of data with respect to one or more satellites.

6. The portable communications device of claim 1, wherein the at least one solar cell is configured to recharge at least one internal battery used to power at least the circuitry.

7. The portable communications device of claim 1, wherein the first and second housing portions have a slim form factor and are foldable, with respect to each other, to modify an effective size of the portable communications device.

8. The portable communications device of claim 1, further comprising one or more connectors connectable to one or more additional power sources.

9. The portable communications device of claim 8, wherein the one or more additional power sources include at least one of a generator or a wall outlet.

10. The portable communications device of claim 1, wherein the at least one tile array is modular and scalable.

11. The portable communications device of claim 1, wherein one or more additional solar panels are able to be interconnected with the second housing portion for applications requiring higher direct current (DC) power.

12. The portable communications device of claim 1, wherein the transmission and reception is performed using a single APA antenna assembly capable of concurrent transmission and reception.

13. The portable communications device of claim 1, wherein the at least one tile array is able to track onto one or more satellites when a user is either stationary or moving by using an inertial navigation unit (INU).

14. The portable communications device of claim 1, wherein multiple array panels are able to be interconnected to synthesize larger array sizes to accommodate increased data rate and capacity.

15. A satellite communication system including a housing comprising at least a first housing portion and a second housing portion connected by a hinge mechanism, the first housing portion including at least one tile array for transmitting and receiving data, the second housing portion including a solar cell array to provide power to the at least one tile array and supporting circuitry of the satellite communication system.

16. The satellite communication system of claim 15, wherein the tile array is an active phased array (APA) antenna or an active electronically scanned array (AESA) antenna.

17. The satellite communication system of claim 15, wherein the housing includes a connector for at least one additional hinge mechanism allowing for hinged connection of at least one additional array of solar cells or additional tile array.

18. The satellite communication system of claim 15, wherein the first housing portion further includes at least one user interface element allowing for user control of the satellite communication system.

19. The satellite communication system of claim 15, wherein the first housing portion further includes at least one processor and memory for processing data that is received from, or to be transmitted to, at least one satellite.

20. The satellite communication system of claim 15, wherein the satellite communication system is able to function as a hotspot to one or more wirelessly connected devices, allowing the one or more wirelessly connected devices to share in transmission and reception of data with respect to one or more satellites.
